(19) United States
(12) Patent Application Publication
(10) Pub. No.: US 2012/0107602 A1
(43) Pub. Date: May 3, 2012

(54) METHOD FOR PRODUCING HYDROPHILIC EXPANDED POLYTETRAFLUOROETHYLENE AND THE PRODUCTS THEREOF

(75) Inventor: Daniel C. Chung, Princeton, NJ (US)

(73) Assignee: WHITFORD CORPORATION, Elverson, PA (US)

(21) Appl. No.: 13/279,464

(22) Filed: Oct. 24, 2011

Related U.S. Application Data
(60) Provisional application No. 61/407,225, filed on Oct. 27, 2010.

(51) Int. Cl. B32B 27/20; B32B 27/14; C08J 9/06; B32B 5/22

(52) U.S. Cl. 428/312.6; 428/317.9; 428/312.8; 264/53

(57) ABSTRACT

A method of treating an article made of a fluoropolymer such as PTFE and, in particular, expanded PTFE (ePTFE), to provide a hydrophilic surface characteristic to the article. A filler is dispersed in a solvent and combined with PTFE to form a paste, which is extruded to form a shaped article and then expanded to form a porous ePTFE article, such as a tubular filter, for example, that includes filler particles dispersed and embedded within the bulk ePTFE. Functional groups of at least some of the filler particles are exposed at the surfaces or within the pores of the ePTFE article, which serve as reaction sites for a hydrophilic treatment by which hydrophilic molecules are chemically bound to the filler particles to thereby provide the surface and/or pores of the ePTFE article with a hydrophilic characteristic.

### CROSS REFERENCE TO RELATED APPLICATIONS

The present application claims priority under Title 35, U.S.C. §119(e) to U.S. Provisional Patent Application Ser. No. 61/407,225, filed on Oct. 27, 2010, entitled MATERIALS AND METHODS FOR PRODUCING AND USING HYDROPHILIC EXPANDED POLYTETRAFLUOROETHYLENE, the entire disclosure of which is hereby expressly incorporated by reference herein.

### BACKGROUND

1. Field of the Invention

The present invention is a method of forming and treating an article made of a fluoropolymer such as polytetrafluoroethylene (PTFE) and, in particular, expanded PTFE (“PTFE”) to provide a more hydrophilic surface characteristic to the article.

2. Description of the Related Art

Expanded polytetrafluoroethylene (ePTFE) is widely used in the manufacture of a number of products, due to its high tensile strength, heat resistance, and chemical resistance. Depending upon how it is manufactured, it is possible to carefully control the porosity of ePTFE materials making them especially suitable for use in applications that involve sealing, venting or filtering. Accordingly, ePTFE is widely used in the production of outerwear, sporting wear and equipment, filtration systems, medical devices and the like.

Untreated ePTFE is extremely hydrophobic and readily repels water and water based solutions. In fact, ePTFE it may be regarded as oleophilic, actually attracting hydrophobic compounds. Various attempts to alter the hydrophobicity of ePTFE in order to produce a material that does not readily attract oils, or that readily attracts hydrophilic compounds, have been undertaken. Some of these approaches include, for example, treating the surface of ePTFE by providing same with a metal oxide coating. While the surfaces of an ePTFE that is coated with a metal oxide is more hydrophilic than a similar surface not coated with a metal oxide, the chemical inertness of ePTFE materials makes it difficult to effectively bond metal oxides to ePTFE surfaces using conventional methods. The metal oxide is therefore not durably bonded to the ePTFE and accordingly, the hydrophilic properties of an ePTFEs conventionally coated with a metal oxide declines over time, especially if the material is repeatedly exposed to water which tends to wash off the metal oxides.

Another approach for creating ePTFE with a hydrophilic surface involves coating ePTFE with silicone to alter the interaction of the surface of the ePTFE with water. While this approach has shown some utility, the hydrophilic properties of silicone coated ePTFE degrades over time when the material is repeatedly or continuously placed in contact with water.

Accordingly, there is a need for a method of forming an ePTFE article having a durable hydrophilic surface, using known machinery that is currently used to produce conventional ePTFE.

### SUMMARY

The present invention provides a method of treating an article made of a fluoropolymer such as PTFE and, in particular, expanded PTFE (ePTFE), to provide a hydrophilic surface characteristic to the article. A filler is dispersed in a solvent and combined with PTFE to form a paste, which is extruded to form a shaped article and then expanded to form a porous ePTFE article, such as a tubular filter, for example, that includes filler particles dispersed and embedded within the bulk ePTFE. Functional groups of at least some of the filler particles are exposed at the surfaces or within the pores of the ePTFE article, which serve as reaction sites for a hydrophilic treatment by which hydrophilic molecules are chemically bound to the filler particles to thereby provide the surface and/or pores of the ePTFE article with a hydrophilic characteristic.

Advantageously, only a relatively small amount of filler is required, such that the ePTFE retains the overall characteristics of PTFE such as chemical inertness, while the mechanical properties of the ePTFE are also not changed. Further, due to the secure embedment of the filler in the ePTFE and the strong bond between the filler and the hydrophilic molecules, the hydrophilic characteristic imparted to the surface of the ePTFE article does not significantly diminish over prolonged exposure to aqueous environments.

In one form thereof, the present invention provides a method of forming an article having a hydrophilic surface characteristic, including the steps of forming a paste including polytetrafluoroethylene (PTFE), a filler, and a solvent, the filler present in an amount of between 0.03 wt. % and 1.0 wt. % based on the combined weight of the PTFE and the filler; extruding the paste to form an article; expanding the article under heat to remove the solvent and form an expanded PTFE (ePTFE) article having at least one surface with a plurality of pores with at least some of the particles of the filler being exposed at the surface and within the pores; and contacting the article with a treatment solution of hydrophilic molecules to bond the hydrophilic molecules to the filler particles, the hydrophilic molecules being exposed to impart a hydrophilic surface characteristic to the article.

In another form thereof, the present invention provides an article having a hydrophilic surface characteristic, including a body formed of expanded polytetrafluoroethylene (ePTFE), the body having at least one surface with a plurality of pores; a particulate filler dispersed within the body at an amount between 0.03 wt. % and 1.0 wt. % based on the combined weight of the ePTFE and the filler, at least some of the particles of the filler being exposed at the surface and within the pores; and hydrophilic molecules bonded to the exposed filler particles, the hydrophilic molecules being exposed to impart a hydrophilic surface characteristic to the article.

### BRIEF DESCRIPTION OF THE DRAWINGS

The above-mentioned and other features of the disclosure, and the manner of attaining them, will become more apparent and will be better understood by reference to the following description of embodiments of the invention taken in conjunction with the accompanying drawings, wherein:

FIG. 1 is a graph of pressure vs. flow rate for untreated samples according to Example 3;

FIG. 2 is a graph of pressure vs. flow rate for treated samples according to Example 3; and

FIG. 3 is a graph of pressure vs. flow rate for treated and washed samples according to Example 3.

Corresponding reference characters indicate corresponding parts throughout the several views. The exemplifications set out herein illustrate embodiments of the disclosure and such exemplifications are not to be construed as limiting the scope of the invention in any manner.

### DETAILED DESCRIPTION

The article having a hydrophilic surface characteristic that is formed according to the present method includes a body formed of ePTFE, which may be in the form of a sheet, membrane, tube, or any other shape, and may be used for an application in which the article is exposed to an aqueous environment. In one embodiment, the article is used as a filter or is used as a component of a filtration device, though other applications, such as clothing, are also possible.

Suitable PTFE used to form ePTFE articles by the present method include traditional high molecular weight PTFEs having a number average molecular weight (Mₙ) of at least 500,000, or at least 1,000,000, and may be in the form of liquid dispersions and/or powders which are available from many commercial sources. Typically, as described below, PTFE powders are used.

In some embodiments, the PTFE may include a small amount of modifying co-monomer, in which case the PTFE is a co-polymer known in the art as “modified PTFE” or “trace modified PTFE”. Examples of the modifying co-monomer include perfluoropropylvinylether (PPVE), other modifiers, such as hexafluoropropylene (HFP), chlorotrifluoroethylene (CTFE), perfluorobutylethylene (PFBE), or other perfluoroalkylvinylethers, such as perfluoromethylvinylether (PMVE) or perfluoroethylvinylether (PEVE). The modifying co-monomer will typically be present in an amount less than 1% by weight, for example, based on the weight of the PTFE.

The PTFE may be produced by a polymerization process that is well known in the art as dispersion polymerization or emulsion polymerization to yield a PTFE fine powder or a PTFE micropowder. Alternatively, the PTFE may be produced by a process that is well known in the art as granular or suspension polymerization, which yields PTFE known in the art as granular PTFE resin or granular PTFE molding powder.

Suitable filler materials include metal oxides, such as aluminum oxide, titanium dioxide, silicon oxide, and calcium oxide, for example. One particular filler material that may be used is fumed silica.

The amount of filler material used is between 0.03 wt. % and 1.0 wt. % based on the combined weight of filler and ePTFE/PTFE, in particular, the amount of filler used may be as low as 0.03 wt. %, 0.05 wt. %, 0.075 wt. %, 0.1 wt. %, 0.2 wt. %, 0.3 wt. %, or 0.4 wt. % and may be as high as 0.5 wt. %, 0.7 wt. %, 0.8 wt. %, 0.9 wt. %, or 1.0 wt. %, any value therebetween, or within any range delimited by any pair of the foregoing values. One suitable range is between 0.1 wt. % and 0.5 wt. %. One suitable fumed silica is Aerosil® 200, a hydrophilic fumed silica having a BET surface area of 200±25 m²/g, available from Evonik Industries (Aerosil® is a registered trademark of Evonik Degussa GmbH). The average particle size of the filler will typically be submicron, i.e., 1.0 microns or less, or may be less than 1.0 micron, as determined by a laser diffraction method or dynamic light scattering method, for example.

The filler may be granulated for easier handling and/or may be finely ground or otherwise processed to create fine particles which readily disperse into a solvent or lubricant, and the filler may optionally be further treated with a wetting agent, emulsifier, or other liquid to render it easier to handle. As discussed herein, the amount of filler used in proportion to the amount of the bulk PTFE/ePTFE of the article is relatively small, such that the ePTFE article formed by the present process retains the characteristics of PTFE, such as chemical inertness, and the mechanical properties of the ePTFE article are not adversely affected.

In a first step of the present method, the PTFE and filler are combined with a solvent or lubricant to form a paste. The filler may be first dispersed in the solvent which, in one embodiment, is an isoparrafin such as Isopar® H or similar, available from ExxonMobil Chemical (Isopar is a registered trademark of Exxon Mobil Corporation). The solvent used to dissolve or wet the filler is readily miscible with the filler, and is sufficiently volatile to be readily and entirely lost from the mixture of PTFE and filler upon application of heat during the expansion process, as described below.

The PTFE is then mechanically mixed with the filler and solvent mixture to form a paste. Any mixing method can be used including mixing, rolling beating, tumbling, swirling, stirring, extruding, and the like, using a paddle mixers, V-cone blenders, drum mixers, rolling devices, screws, extruders, etc. In this manner, the filler is physically mixed with, and embedded within, the PTFE.

The resulting paste is then subjected to at least one process that changes or otherwise alters the shape of the material, such as paste extrusion to form a shaped article. The shaped article is then subjected to an expanding process to form an article of ePTFE. Such processes are generally known, and described in detail in U.S. Pat. No. 3,953,566, which is incorporated herein by reference in its entirety. Typically, the article is physically stretched, for example, by rolling it between rollers in combination with elevating the temperature of the mixture, such as above 300° C., for example to drive off the solvent. The article is then allowed to cool to ambient temperature. This process will typically create open areas within the material, such as pores or gaps, for example, which may alter the density of the article. This process may also alter the physical properties of the PTFE, for example, by making it stronger, or more elastic, or by altering the ratio of tensile strength to mass of the material.

Further, if the article is stretched under elevated temperatures resulting in an alteration in the physical properties of the material, such as a decrease in density and/or an increase in its tensile strength, the article may be held under stress for some time at a temperature greater than ambient temperature. The temperature may then be reduced while continuing to subject the article to at least a portion of the applied stress. Factors such as the amount of physical force applied, the temperature, the composition of the bulk material and filler mixture, and curing temperature may be adjusted to influence the final shape and/or physical properties of the article.

The size of the pores formed in the ePTFE and, in turn, the density of the ePTFE, can be controlled by adjusting a number of parameters known in the art such as changing the composition of the PTFE and/or the type of filler added to the bulk material, adjusting the temperature under which the material is expanded and/or the length of time that the ePTFE material is exposed to an elevated temperature, and/or by adjusting the amount of stress the material is placed under during and immediately after expansion. By adjusting these and other parameters it is possible to control the number of pores in a given area of ePTFE and/or the average size of the pores in the material.

The foregoing process by which filler particles are dispersed and physically embedded or anchored within the bulk material of the ePTFE results in the introduction of reactive sites into the ePTFE article, which is itself otherwise very inert and non-reactive. As described below, the article thus formed is then treated to impart a hydrophilic surface characteristic by reacting hydrophilic molecules with chemically reactive groups of the filler particles that are spatially exposed at the surface(s) and/or within the pores of the article.

The hydrophilic molecules will typically be provided in the form of a treatment solution which is contacted with the ePTFE article. The hydrophilic molecules react spontaneously with the reactive groups of the filler to bind the hydrophilic molecules to the surface of the article to impart a hydrophilic surface characteristic to the article. In this manner, the treated article is more hydrophilic than the ePTFE bulk material of the article absent the filler and/or hydrophilic molecules. In some embodiments, the filler itself is more hydrophilic than the ePTFE bulk material of the article and provides a surface that is more hydrophilic than the surface of ePTFE bulk material in the absence of the filler. However, in most cases it is desirable to minimize the amount of filler used, with the hydrophilic molecules that are bound to the filler providing a much more enhanced hydrophilic surface that that which would be provided by the incorporation of the filler alone within the ePTFE bulk material.

Suitable hydrophilic molecules include hydrophilic silanols such as tetraethyl orthosilicate (TEOS) which, upon reacting with the reactive groups of the filler, form a durable, hydrophilic surface on the ePTFE article.

To the extent that the reaction between the functional groups of the filler and the hydrophilic molecules is not spontaneous, the reaction may be induced and/or accelerated by elevating the temperature of the treatment solution and/or by the use of a catalyst. For embodiments in which silica is the filler and tetraethyl orthosilicate (TEOS) is the hydrophilic molecule, one suitable catalyst is dibutyltin dilaurate.

Further, after treatment with the hydrophilic molecules, the ePTFE article may optionally be washed with an acid, a base, or with water. This washing treatment hydrolyzes any residual ethoxy groups of the TEOS that were not previously hydrolyzed to hydroxyl groups prior to the bonding of the hydrolyzed TEOS to the functional groups of the filler. An acid or base wash will hydrolyze any residual ethoxy groups more rapidly, though a water wash will accomplish the same result given relatively more time.

An exemplary chemical pathway of the present process is set forth below. Referring to Formula 1, a fumed silica filler may include siloxane (Si—O—Si) moieties embedded within the bulk ePTFE of the article, with exposed silanol (Si—OH) function groups concentrated on or near the surface of the material:

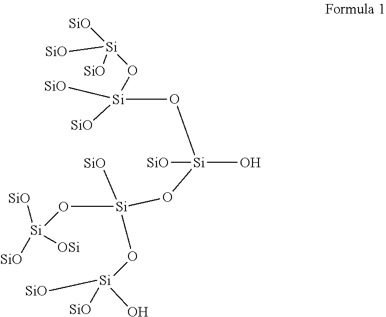

Tetraethyl orthosilicate (TEOS) is shown in Formula 2 below, with m=1:

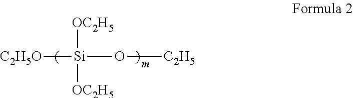

Other silanes wherein m is greater than 1 may also be used. In the presence of water, the ethoxy functional groups of TEOS readily hydrolyze to silanol groups, thereby forming a silanol according to Formula 3 below,

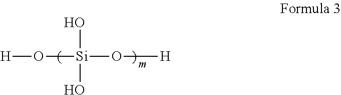

wherein m≧1. When the hydrolyzed TEOS molecules contact the hydrophilic silica in the presence of a catalyst such as dibutyltin dilaurate, the silanols condense to form new siloxane linkages, which chemically and durably bind the hydrolyzed TEOS molecules to the hydrophilic silica, as per Formula 4 below:

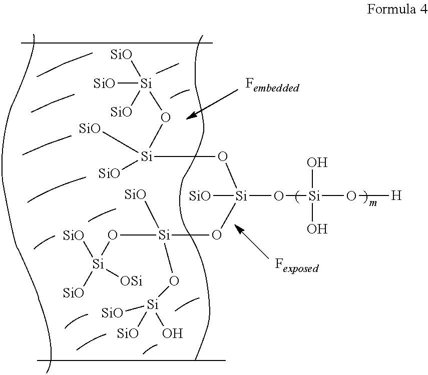

As schematically illustrated in Formula 4 above, some of the filler, designated F_{embedded}, is embedded within the bulk ePTFE material, while some of the surfaces or functional groups of the filler, designated F_{exposed}, are exposed at the surface and/or within the pores of the bulk ePTFE material. These exposed functional groups of the filler F_{exposed} are available for bonding with the hydrophilic molecules upon treatment with TEOS as described above. In this manner, the hydrophilic TEOS molecules which bond to the exposed surfaces or functional groups of the filler are in turn fully exposed at the surface and/or within the pores of the bulk ePTFE or the article, with each TEOS molecule presenting a plurality of hydrophilic hydroxyl groups for interaction with water molecules to thereby provide a hydrophilic surface characteristic to the article.

Advantageously, in the present process only a relatively small amount of filler is required, such that the ePTFE retains the characteristics of the PTFE of the ePTFE bulk material, such as chemical inertness, and the mechanical properties of the ePTFE are also not changed. Further, due to the secure embedment of the filler in the ePTFE and the strong bond between the filler and the hydrophilic molecules, the hydrophilic characteristic imparted to the surface of the ePTFE article does not significantly diminish over prolonged exposure to aqueous environments.

### EXAMPLES

The following non-limiting Examples illustrate various features and characteristics of the present invention, which is not to be construed as limited thereto. Throughout the Examples and elsewhere herein, percentages are by weight unless otherwise indicated.

### Example 1

### Production of ePTFE Tubing

Hydrophilic fumed silica (Aerosil 200, available from Evonik Degussa GmbH, Frankfurt, Germany) was dispersed in an isoparaffinic solvent (Isopar H, available from Exxon-Mobil, Houston, Tex.) with the silica at 3 wt. % and the solvent at 97 wt. % based on the combined weight of silica and solvent. This mixture was then diluted at a 4:1 ratio with additional solvent. Bulk PTFE powder (Daikin America, Orangeburg, N.Y.) was then mixed into the this material using a V-cone blender to form a paste comprising, with the aforementioned 4:1 dilution ratio, about 81.5 parts PTFE, about 17.3 parts solvent, and about 0.2 parts fumed silica, resulting in a material that includes 0.226 wt. % fumed silica. Other mixtures having varying amounts of silica were prepared in a similar manner with various dilutions of additional solvent.

The paste was then paste extruded into a cylindrical shaped article or tube, which was then expanded to produce ePTFE by rapid stretching while being heated to a temperature in excess of 300° C. to drive off virtually all of the solvent, and then allowed to cool to ambient temperature. Further details of this known expansion process are set forth in U.S. Pat. No. 3,953,566, which is incorporated herein by reference in its entirety.

The silica filled, ePTFE tube was then treated with a solution of 5 wt. % TEOS (Silbond 40, available from Silbond Corp, Weston, Mich.) in isopropyl alcohol (IPA). The TEOS/IPA solution included about 0.5 wt. % dibutyltin dilaurate (Dabco T-12, available from Air Products, Allentown, Pa.). The treated ePTFE tubing was then cured in a box oven at about 300° F. for about 30 minutes. In some embodiments, the finished ePTFE tubing was washed with either an acid solution or an alkaline solution or successive acid and alkaline washes.

### Example 2

### Measuring Flow Rates Using ePTFE Tubing Having Differing Amounts of Filler

As set forth in Table 1 below, ePTFE tubing filled with different amounts of silica and expanded to different densities was treated with 5 wt. % TEOS and 0.5% dibutyltin dilaurate in IPA as set forth in Example above was cured at 400° F. to form a hydrophilic, treated surface (T). Other tubing made by filling ePTFE with similar amounts of silica were either untreated (U) or treated and conditioned with a mixture of acetic acid, ethanol and water (T+H) according to the methods set forth above. Samples of the different tubes were measured to determine the back pressure expressed in pounds per square inch (psi) at a constant flow rate. The results of these tests are summarized in Table 1 below.

More particularly, in order to measure the relative ability of different materials comprising ePTFE to pass through the tubing, the tubing samples were connected to a device that applies water (or other aqueous liquids) to one end of the tube while the other end of the tube is closed to prevent linear flow of the liquid directly through the interior of the tube. The outside of the tube is observed as the pressure of the liquid applied to the tubing is increased. The pressure at the first appearance of liquid beads on the surface of the tubing is noted and recorded as the “breakthough pressure.” These values measured with different tubing made from various materials are reported in Table 1 below, in which the ratios indicate amount of solvent/lubricant to amount solvent/lubricant including with 3 wt. % silica that was added to the bulk PTFE before expanding the mixture to form ePTFE.

TABLE 1
Breakthrough pressure (in psi) measured at a constant flow rate
of a water based solution determined with different forms of ePTFE

| | Silica loading | 1.2 g/cc | 1.1 g/cc | 1.0 g/cc | 0.9 g/cc |
|---|---|---|---|---|---|
| Sample | (wt. %) | density | density | density | density |
| Control (U) | 0.0 | 15 | >12.5 | 12.5 | 10 |
| Control (T) | 0.0 | 12.5 | 10 | 10 | 8 |
| Control (T + H) | 0.0 | <12 | | | |
| 29:1 (U) | 0.037 | 15 | 12.5 | 12.5 | 10 |
| 29:1 (T) | 0.037 | 12.5 | 8 | 10 | 7 |
| 29:1 (T + H) | 0.037 | | | | 5 |
| 9:1 (U) | 0.113 | 12.5 | 12.5 | 10 | 10 |
| 9:1 (T) | 0.113 | 12.5 | 10 | <10 | 7 |
| 9:1 (T + H) | 0.113 | | 10 | | |
| 4:1 (U) | 0.226 | 15 | <12.5 | <12.5 | 8 |
| 4:1 (T) | 0.226 | 12.5 | 10 | 8 | 8 |
| 4:1 (T + H) | 0.226 | | | 8 | |

In the table above, samples having a 1.2 g/cc density have a correspondingly relatively lower porosity, while samples having a 0.9 g/cc density have a correspondingly relatively higher porosity. As will be apparent from the data in the table above, the breakthrough pressure is a function of both the density (porosity) and the amount silica loading and thereby consequent amount of exposed hydrophilic particles available to interact favorably with the water. Samples having relatively lower porosities and/or relatively lesser amounts of silica loading will have relatively greater breakthrough pressures that samples having relatively higher porosities and/or relatively greater amounts of silica loading.

### Example 3

### Flow Rates Measured Using ePTFE Membranes with Differing Amounts of Fumed Silica

In order to measure the rate that an aqueous solution was able to flow through various materials made from treated and untreated ePTFE, flexible tubes made from various materials were connected to a source of an aqueous fluid such as water. Water was then forced through the membranes at a set pressure, for example, 43 pounds per square inch (PSI), and the rate of water eluted through the membrane was measured. In order to ensure that the values obtained using this test could be compared to another, the rates were measured for each material under essentially the same temperature and ambient pressure. The flow rates measured using various forms of ePTFE both treated and untreated that were tested are reported in Tables 2 and 3 below.

Hydrophilic ePTFE tubes were formed using different levels of fumed silica in accordance with the method of Example 1 above. The density and inner diameter (I. D.) and outer diameters (O. D.) of these tubes are shown in Table 2 below.

TABLE 2
Fumed silica loading and physical properties

| | | Silica | | | |
|---|---|---|---|---|---|
| | Fumed silica | loading | Density | I.D. | O.D. |
| Sample | loading ratio | (wt. %) | (g/cm³) | (mm) | (mm) |
| A | 4:1 | 0.226 | 0.98 | 1.60 | 2.03 |
| IIA | 2:1 | 0.376 | 1.30 | 1.60 | 2.04 |
| B | 4:1 | 0.226 | 1.21 | 1.65 | 2.08 |
| IIB | 2:1 | 0.376 | 1.00 | 1.60 | 2.07 |

Membranes produced using the treated ePTFE material disclosed herein were tested along with ePTFE that was not treated. Membranes made from different formulations of ePTFE and silica were either treated with TEOS to form a treated material (C) or not treated with TEOS to form an untreated material (U). Both the treated and untreated membranes were washed with an alkaline solution.

Membranes made from various materials were tested by measuring the rate of flow of an aqueous solution through the membrane at different pressures. The first column in Tables 3 and 4 below lists the ratio of the solvent/lubricant to solvent/lubricant including with 3 wt. % silica that was added to the bulk PTFE before expanding the mixture to form ePTFE. For example, the sample designated at 4:1 was formed using 4 parts of solvent/lubricant to every 1 part of solvent/lubricant that included 3 wt. % silica.

Density is an indicator of porosity, i.e., the more porous the material the lower its density. In general, the larger or more numerous the pores in a given material are, the higher will be the flow rate measured with the materials. Usually, hydrophilic materials exhibit higher flow rates of aqueous solvents than hydrophobic materials.

Hollow tubes were made from different forms of ePTFE as set forth in Table 2 above. The tubes were connected to a source of water and the water was forced through the tubes. The rate of water passing through the tubes was measured as a function of the pressure applied to the water.

The volumetric flow rates of aqueous solutions through hollow tubes listed in Table 2 were measured over a range of pressures (bar) for the materials.

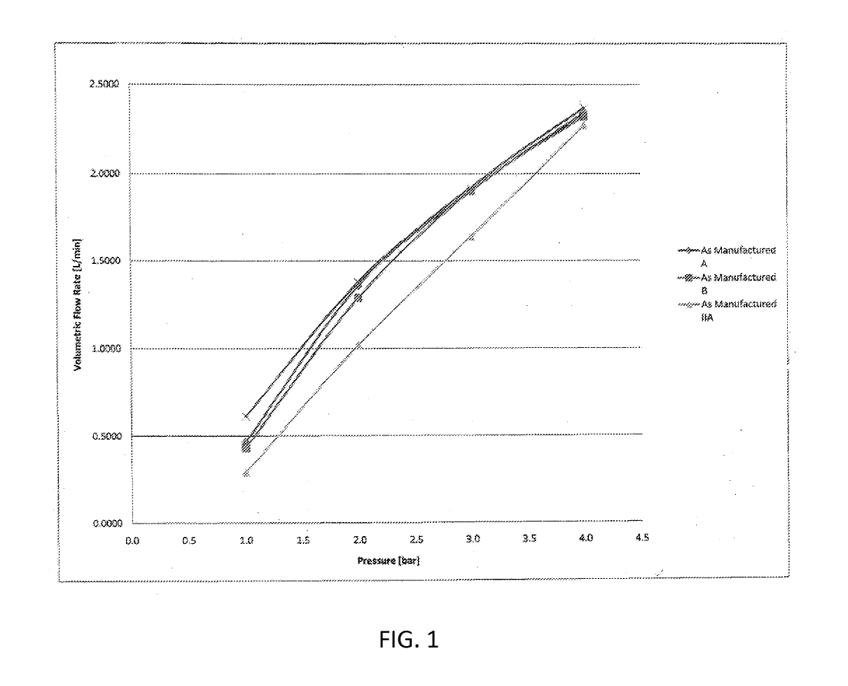

Referring now to FIG. 1, a graph of these flow rates measured for tubes A, B, IIA and IIB is illustrated for the tubes as manufactured (before treatment with TEOS). Hollow tubes made from ePTFE filled with the lowest amount of fumed silica and having the highest density (IIA) exhibited the lowest volumetric flow rates at each pressure tested. Flow rates measured for tubes made using the other materials were similar to one another.

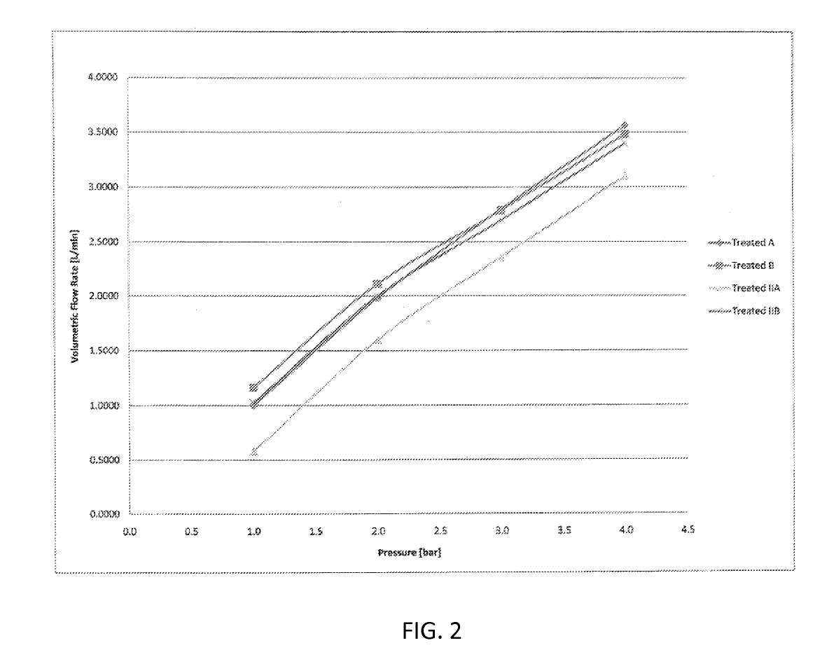

Referring now to FIG. 2, a graph of flow rates measured for tubes A, B, IIA and JIB is illustrated for the tubes after treatment with TEOS. Flow rates for all of the tubes increased after treatment compared with the plots of FIG. 1. Again, tubes made from ePTFE with the highest density and highest loading of fumed silica (IIA) exhibited the lowest volumetric flow rate.

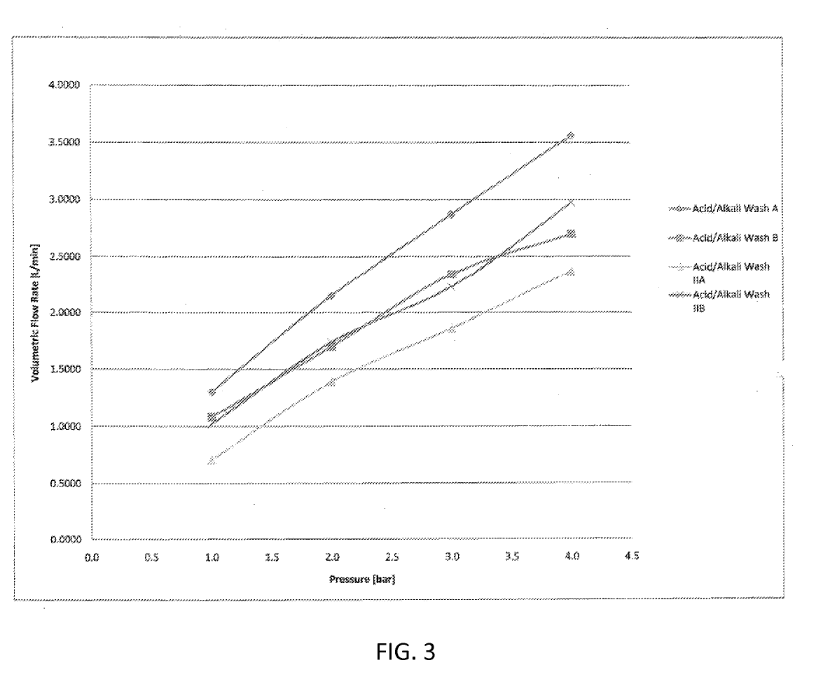

Referring now to FIG. 3, a graph of flow rates measured for tubes A, B, IIA and IIB is illustrated for the tubes after treatment with TEOS and after further washing with acid and alkali solutions. Washing the treated tubes with acid followed by treating with an alkaline solution increased the volumetric flow rates of all of the tubes tested as may be seen by comparing FIGS. 2 and 3. Again, tubes made from ePTFE with the highest density and highest loading of fumed silica (IIA) exhibited the lowest volumetric flow rate. Tubes made from washed material with the lowest density and lowest loading of fumed silica (A) exhibited the highest volumetric flow rate at each pressure tested.

TABLE 3
Flow rates tested using material formed at a 4 to 1 ratio
of ISOPAR to 3% fumed silica in solvent/lubricant

| | Silica | | | | |
|---|---|---|---|---|---|
| | loading | | Flow | | Flow |
| Sample/Density | (wt. %) | Psi 1 | (mL/min) | Psi 2 | (mL/min) |
| 4:1 1.2 g/cm\hat{ }3 U | 0.226 | 43.0 | 10.5 | 49.5 | 13.5 |
| 4:1 1.2 g/cm\hat{ }3 M | 0.226 | 43.0 | 11.0 | 49.5 | 17.0 |
| 4:1 1.2 g/cm\hat{ }3 C | 0.226 | 43.0 | 13.5 | 49.5 | 25.0 |
| 4:1 1.1 g/cm\hat{ }3 U | 0.226 | 43.0 | 21.0 | 49.5 | 43.0 |
| 4:1 1.1 g/cm\hat{ }3 C | 0.226 | 43.0 | 32.0 | 49.5 | 43.0 |
| 4:1 1.0 g/cm\hat{ }3 U | 0.226 | 43.0 | 38.0 | 49.5 | 55.0 |
| 4:1 1.0 g/cm\hat{ }3 C | 0.226 | 43.0 | 85.0 | 49.5 | 96.0 |
| 4:1 .90 g/cm\hat{ }3 U | 0.226 | 43.0 | 80.0 | 49.5 | 97.0 |
| 4:1 .90 g/cm\hat{ }3 C | 0.226 | 43.0 | 131.0 | 49.5 | 128.0 |

TABLE 4
Flow rates tested using material formed at a 9 to 1 ratio
of ISOPAR to 3% fumed silica in solvent/lubricant

| | Silica | | | | |
|---|---|---|---|---|---|
| | loading | | Flow | | Flow |
| Sample/Density | (wt. %) | Psi 1 | (mL/min) | Psi 2 | (mL/min) |
| 9:1 1.2 g/cm\hat{ }3 U | 0.113 | 43.0 | 14.0 | 49.5 | 18.0 |
| 9:1 1.2 g/cm\hat{ }3 C | 0.113 | 43.0 | 22.0 | 49.5 | 21.0 |
| 9:1 1.1 g/cm\hat{ }3 U | 0.113 | 43.0 | 14.0 | 49.5 | 26.0 |
| 9:1 1.1 g/cm\hat{ }3 C | 0.113 | 43.0 | 31.0 | 49.5 | 48.0 |
| 9:1 1.0 g/cm\hat{ }3 U | 0.113 | 43.0 | 22.0 | 49.5 | 37.0 |
| 9:1 1.0 g/cm\hat{ }3 C | 0.113 | 43.0 | 79.0 | 49.5 | 88.0 |
| 9:1 .90 g/cm\hat{ }3 U | 0.113 | 43.0 | 53.0 | 49.5 | 84.0 |
| 9:1 .90 g/cm\hat{ }3 C | 0.113 | 43.0 | 90.0 | 49.5 | 111.0 |

Still another measurement of a membrane's performance is the pressure measured for a given solution at a set temperature and flow rate. The lower the back pressure measured at a given flow rate the more readily the membrane passes the liquid being passed through the membrane. As may be seen from Tables 3 and 4 above, at all of the densities tested and in both ratios of silica to ePTFE tested, membranes made from materials treated with hydrophilic silanol groups exhibited either comparable or in most cases higher flow rates of aqueous solutions at comparable pressures than silica filled ePTFE that was not treated with hydrophilic silanol groups.

While this disclosure has been described as having exemplary designs, the present disclosure can be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

What is claimed is:

1. A method of forming an article having a hydrophilic surface characteristic, comprising the steps of:
forming a paste including polytetrafluoroethylene (PTFE), a filler, and a solvent, the filler present in an amount of between 0.03 wt. % and 1.0 wt. % based on the combined weight of the PTFE and the filler;
extruding the paste to form an article;
expanding the article under heat to remove the solvent and form an expanded PTFE (ePTFE) article having at least one surface with a plurality of pores with at least some of the particles of the filler being exposed at the surface and within the pores; and
contacting the article with a treatment solution of hydrophilic molecules to bond the hydrophilic molecules to the filler particles, the hydrophilic molecules being exposed to impart a hydrophilic surface characteristic to the article.

2. The method of claim 1, wherein said forming step comprises forming a paste including polytetrafluoroethylene (PTFE), a filler, and a solvent, the filler present in an amount of between 0.1 wt. % and 1.0 wt. % based on the combined weight of the PTFE and the filler.

3. The method of claim 1, wherein said forming step comprises forming a paste including polytetrafluoroethylene (PTFE), a filler, and a solvent, the filler present in an amount of between 0.1 wt. % and 0.5 wt. % based on the combined weight of the PTFE and the filler.

4. The method of claim 1, wherein in said contacting step, the treatment solution additionally includes a catalyst.

5. The method of claim 1, wherein in said contacting step, the hydrophilic molecules are a hydrophilic silanol.

6. An article produced by the method of claim 1.

7. The article of claim 6, wherein the article is a filtration component.

8. An article having a hydrophilic surface characteristic, comprising:
a body formed of expanded polytetrafluoroethylene (ePTFE), said body having at least one surface with a plurality of pores;
a particulate filler dispersed within said body at an amount between 0.03 wt. % and 1.0 wt. % based on the combined weight of said ePTFE and said filler, at least some of the particles of said filler being exposed at said surface and within said pores; and
hydrophilic molecules bonded to said exposed filler particles, the hydrophilic molecules being exposed to impart a hydrophilic surface characteristic to said article.

9. The article of claim 8, wherein said particulate filler is dispersed within said body at an amount between 0.1 wt. % and 1.0 wt. % based on the weight of said ePTFE.

10. The article of claim 8, wherein said particulate filler is dispersed within said body at an amount between 0.1 wt. % and 0.5 wt. % based on the combined weight of the PTFE and the filler.

11. The article of claim 8, wherein said particulate filler is a metal oxide.

12. The article of claim 8, wherein said particulate filler is fumed silica.

13. The article of claim 8, wherein said hydrophilic molecules are a hydrophilic silanol.

14. The article of claim 13, wherein said hydrophilic molecules are tetraethyl orthosilcate (TEOS).
